(19) United States
(12) Patent Application Publication
(10) Pub. No.: US 2006/0248252 A1
(43) Pub. Date: Nov. 2, 2006

(54) Automatic detection of data storage functionality within a docking station

(76) Inventor: Bhupesh D. Kharwa, San Ramon, CA (US)

Correspondence Address: MCANDREWS HELD & MALLOY, LTD, 500 WEST MADISON STREET, SUITE 3400, CHICAGO, IL, 60661, US

(21) Appl. No.: 11/195,179

(22) Filed: Aug. 2, 2005

Related U.S. Application Data
(60) Provisional application No. 60/675,121, filed on Apr. 27, 2005.

(51) Int. Cl. G06F 13/00

(52) U.S. Cl. 710/303; 710/304

(57) ABSTRACT

Herein described is a system and method of detecting the presence of a docking station that provides data storage functionality. The docking station broadcasts a beacon signal to a computing device that is identified by way of a predefined IP multicast address. The beacon signal may be forwarded to the computing device by way of a switching device. The switching device, uses an address resolution logic, and is capable of forwarding one or more data packets which have their destination address set to the predefined IP multicast address. The computing device configured with the predefined IP multicast address recognizes the docking station that broadcasts the beacon signal, as a docking station that provides data storage and data retrieval functionality. The system may be implemented using a server application software resident in the docking station and a client application software resident in each of the one or more computing devices.

### CROSS-REFERENCE TO RELATED APPLICATIONS/INCORPORATION BY REFERENCE

This application makes reference to and claims priority from U.S. Provisional Patent Application Ser. No. 60/675121 (Attorney Docket No. 16640US01), entitled “AUTOMATIC DETECTION OF DATA STORAGE FUNCTIONALITY WITHIN A DOCKING STATION” filed on Apr. 27, 2005, the complete subject matter of which is incorporated herein by reference in its entirety.

This application makes reference to:

U.S. application Ser. No. 11/087136 (Attorney Docket No. 15675US03) filed Mar. 22, 2005; and

U.S. application Ser. No. 11/102441 (Attorney Docket No. 15678US02) filed Apr. 8, 2005.

The above stated applications are hereby incorporated herein by reference in their entireties.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

When docking a notebook computer to a docking station, a user may wish to off-load or synchronize one or more data files from the notebook computer to an external data storage device, such that the available storage capacity of the notebook computer is increased. Unfortunately, off-loading the one or more data files may require a number of time consuming steps. For example, a data storage device must be located. The data storage device may be located remotely within a local area network. Next, one or more data files may need to be selected for off-loading. Then, one or more directories may need to be selected or created in the data storage device for receiving the one or more data files. Thereafter, the one or more data files may be stored in the one or more directories. Overall, the off-loading or synchronization process may involve a number of undesirable or tedious steps.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the invention provide at least a system and a method that allows a user to store data into and retrieve data from a docking station when a portable computing device is connected to the docking station. Aspects of the invention allow the docking station to provide data storage functionality by way of using an integrated data storage device. Further aspects of the invention provide data storage functionality for one or more data computing devices that are networked to the docking station. The various aspects of the invention are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a block diagram of a system that provides automated data storage and retrieval by way of using a docking station having integrated data storage functionality, in accordance with an embodiment of the invention.

FIG. 2 is a block diagram of a data storage device residing within a docking station, in accordance with an embodiment of the invention.

FIG. 3 is an operational flow diagram illustrating a method of detecting the presence of a docking station having data storage functionality and initiating a data storage or data retrieval session, in accordance with an embodiment of the invention.

### DETAILED DESCRIPTION OF THE INVENTION

Various aspects of the invention provide at least a system and method of providing automated data storage and data retrieval when a portable computing device is connected to a docking station having data storage functionality. The portable computing device may comprise a laptop or notebook computer, for example. The automated data storage and data retrieval process may comprise a number of events. For example, the first event may comprise automatic detection of data storage functionality when the portable computing device is physically connected to a docking station having data storage functionality. The events that follow may comprise any number of data storage and/or data retrieval operations. For example, a data synchronization or data back-up may occur when a laptop computer is connected to such a docking station. In another example, automated data archiving may occur using one or more intelligent algorithms when the laptop computer is connected to the docking station. In another example, automated data restoration may occur when the laptop computer is connected to the docking station. The aforementioned data storage and/or data retrieval operations may be automatically provided based on a user's preferences. The user may input his data storage and retrieval preferences using a friendly administrative graphical user interface (GUI), for example. The GUI may be generated using a software application resident in the portable computing device. The software application may be referred to as a client application software, as will be discussed later. In a representative embodiment, data storage functionality provided by the docking station is implemented by way of an integrated data storage device. The data storage device may comprise one or more data storage drives, depending on the data storage capacity requirements of a user. The one or more data storage drives may comprise one or more hard disk drives, for example. In a representative embodiment, the data storage device is capable of storage expansion by way of accommodating one or more additional data storage drives. In a representative embodiment, the docking station may be networked to one or more data computing devices. Because the docking station (by way of the integrated data storage device) is capable of providing data storage functionality to one or more data computing devices in a network, the aforementioned data storage device may be termed or alternatively referred to as a network attached storage device (NAS). The docking station may act as a central depository for any data that is stored or archived by the one or more networked data computing devices. The NAS may comprise one or more data storage drives capable of providing one or more data pools using the one or more data storage drives. Details of the implementation of data pools may be found in reference to U.S. application Ser. No. 11/087136 (Attorney Docket No. 15675US03) filed Mar. 22, 2005, which is hereby incorporated herein by reference in its entirety.

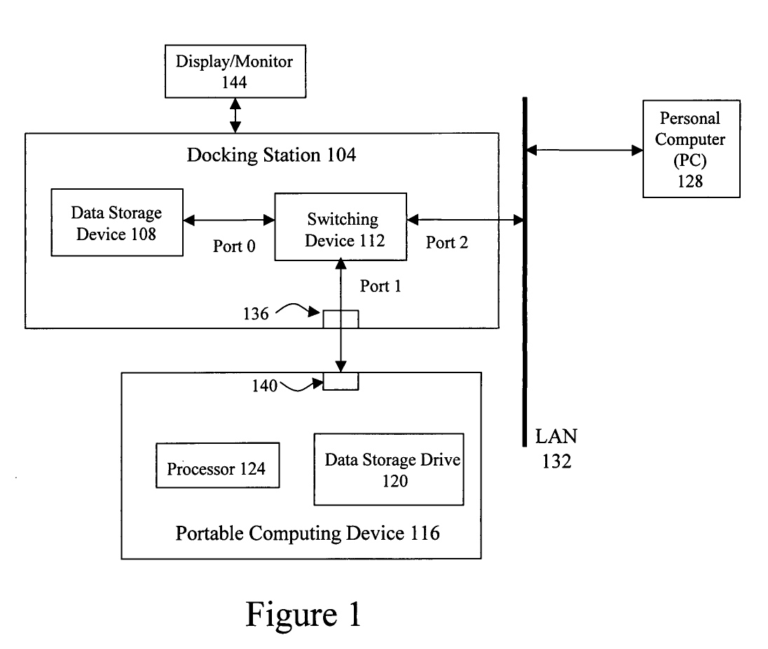

FIG. 1 is a block diagram of a system that provides automated data storage and retrieval by way of using a docking station 104 having integrated data storage functionality, in accordance with an embodiment of the invention. The system comprises a docking station 104 and a portable computing device 116. The docking station 104 may communicate with the portable computing device 116 when the portable computing device 116 is connected to the docking station 104. As illustrated, the docking station 104 may provide access to a large display/monitor 144 and/or to a local area network (LAN) 132, when the portable computing device 116 is connected to the docking station 104, for example. As illustrated in FIG. 1, a docking station interface (I/F) 136 and a portable computing device interface (I/F) 140 are used to physically connect the docking station 104 to the portable computing device 116. As shown, the system may further comprise the local area network (LAN) 132 and one or more computing devices communicatively connected to the LAN 132. The one or more computing devices may comprise one or more docking stations and/or personal computers (PCs), for example. In the exemplary embodiment of FIG. 1, a docking station 104 and a personal computer (PC) 128 are the only devices shown connected to the LAN 132; however, additional computing devices (not shown) may be connected to the LAN 132. The additional computing devices may utilize the data storage functionality provided by the docking station 104. The docking station 104 comprises a data storage device 108, a switching device 112, and a docking station I/F 136. In the representative embodiment of FIG. 1, the switching device 112 provides three physical ports, and they are labeled Port 0, Port 1, and Port 2. The data storage device 108 interfaces with the switching device 112 through Port 0. The switching device 112 interfaces with the portable computing device 116 by way of Port 1. The switching device 112 interfaces with the LAN 132 by way of Port 2. The switching device 112 may comprise any type of switch or router with any number of ports, for example. The switching device 112 may comprise an Ethernet switch with one or more ports, for example. The portable computing device 116 comprises a data storage drive 120, a processor 124, and a portable computing device I/F 140.

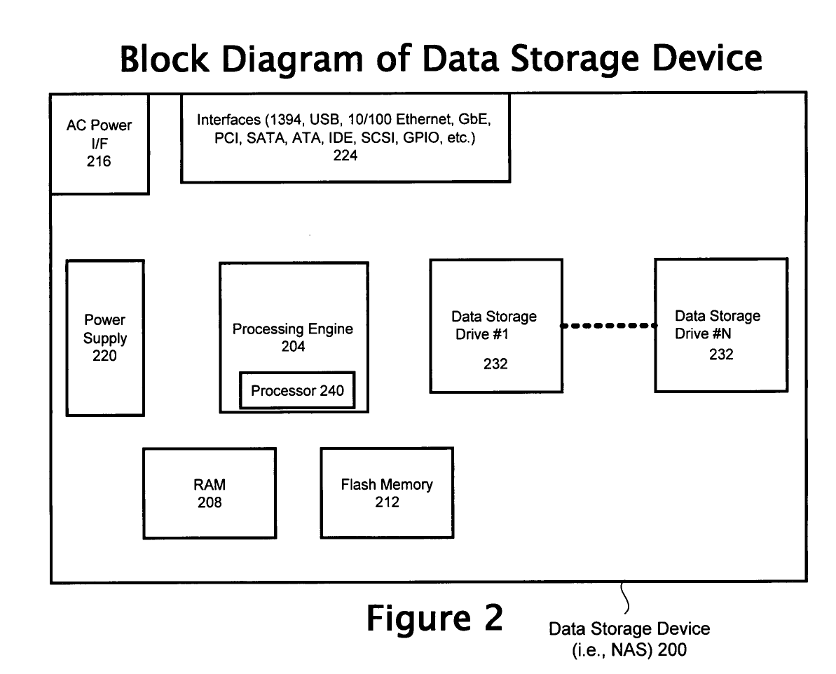

Referring to FIG. 1, automatic detection and subsequent data storage and data retrieval operations are facilitated by way of executing one or more sets of instructions or software resident in the docking station 104 and the portable computing device 116. The software in the docking station 104 may be booted up when the docking station 104 is powered up. Hereinafter, the software in the docking station 104 may be referred to as a server application software. The server application software may reside within the data storage device 108. A processor located within the data storage device 108 may execute the server application software. The server application software may be stored within a memory or a data storage drive of the data storage device 108. Details of the internal structure of the data storage device 108 will be discussed in reference to FIG. 2. The server application software may be used to generate one or more messages or signals identifying that the docking station 104 has data storage functionality. The one or more signals may be described as one or more beacon signals. In a representative embodiment, the server application software broadcasts a beacon signal to the switching device 112. The beacon signal may be sent continuously or periodically based on the set-up or configuration of the data storage device 108. A graphical user interface may be provided to a user when the server application software is executed, such that a preferred configuration may be input. The preferred configuration may specify the preferred periodicity of the beacon signal, for example. The beacon signal is received by the portable computing device 116 by way of the switching device 112. The beacon signal may comprise one or more messages that is recognized by a client application software running on the portable computing device 116, or any other computing device running a copy of the client application software that is connected to the LAN 132 (or network). The client application software may run a service application in the background of an operating system. The service application may monitor any incoming beacon signal. The beacon signal may be used to identify that the docking station 104 it is associated with is a docking station 104 that provides data storage functionality. The beacon signal is configured for transmission to a pre-defined destination network address. The portable computing device 116 and any other computing device (i.e., the personal computer 128) may be configured with the pre-defined network address. The client application software may be loaded and executed when the operating system of the portable computing device 116 (and/or personal computer 128) is booted up, for example. The client application software may configure the portable computing device 116 with the pre-defined network address. The client application software may comprise an application that utilizes a port or logical endpoint. The port may comprise a TCP (transmission control protocol) or UDP (user datagram protocol) port, for example. The port comprises an unassigned port associated with the pre-defined network address. In a representative embodiment, the client application software opens a multicast socket using the pre-defined network address and the unassigned port. The multicast socket is used to listen for an incoming beacon signal. In this representative embodiment, the pre-defined network address may comprise a multicast address (i.e., IP multicast address or internet protocol multicast address). For example, the pre-defined multicast address may be selected from the range of addresses from 224.0.0.0 through 239.255.255.255. In a representative embodiment, the pre-defined multicast address does not use any of the reserved multicast addresses. For example, the range of multicast addresses between 224.0.0.0 and 224.0.0.225 is not used. These reserved multicast addresses may be used for routing protocols and other low-level topology discovery or maintenance protocols, such as gateway discovery and group membership reporting. As a consequence, in a representative embodiment, unreserved (or not reserved) multicast addresses are used. The beacon signal may comprise the MAC address, name, and IP address of the data storage device 108. The beacon message may comprise a TCP or UDP message (i.e., TCP or UDP data packets), for example. The predefined multicast address may utilize a multicast MAC address derived from the multicast address. In a representative embodiment, all docking stations providing data storage functionality and all portable computing devices running the client application software will utilize the same pre-defined multicast address. The processor 124 within the portable data computing device 116 may be used to execute the client application software when the portable computing device 116 is booted up, for example. The client application software may be stored in the data storage drive 120 of the portable computing device 116. The client application software may be automatically executed as a start-up application (in a start-up menu) in a Windows operating system, for example. Optionally, one or more mechanisms may be used as a condition for initiating the detection process. The one or more mechanisms may comprise an authentication mechanism used for authenticating a computing device, such as the portable computing device 116, prior to commencement of the detection process. The one or more mechanisms may comprise the use of an actuator, such as a push button switch, located on the docking station, for example. In this instance, the actuator must be actuated and the docking station must be connected to a portable computing device, in order for automatic detection to occur. One or more representative embodiments related to the implementation and use of the actuator may be found in reference to U.S. application Ser. No. 11/102441 (Attorney Docket No. 15678US02) filed Apr. 8, 2005, which is hereby incorporated herein by reference in its entirety. One or more networked data computing devices (e.g., such as the personal computer 128) that are capable of communicating with the docking station 104 (via a local area network (LAN), for example) may also utilize the same client application software. The client application software may be stored and executed in any of one or more data computing devices in a network. As discussed, executing the client application software configures the portable computing device 116 (or any other computing device that executes a version or copy of the client application software may be configured) such that a beacon signal (transmitted by the docking station 104) is automatically received. For example, the personal computer 128 may also comprise the same client application software. The client application software may be stored in the local hard disk drive of the personal computer 128, for example. Likewise, the client application software may be loaded and executed when the personal computer's operating system is booted up. The operating system of the portable computing device 116 and the personal computer 128 may comprise any type of operating system, such as Microsoft Windows. The client application software may provide one or more graphical user interfaces (GUI) for inputting a user's data storage and data retrieval preferences. For example, one or more parameters may be input into the GUI such that data back-up occurs only on certain times or days of the week.

Referring back to FIG. 1, the switching device 112 provides a mechanism by which data packets whose destination address corresponds to the pre-defined multicast address may be switched, routed, or forwarded to the one or more computing devices pre-configured with a multicast socket having the same pre-defined multicast address. The switching device 112 may utilize address resolution logic (ARL) by which one or more rules may be assigned for forwarding data packets to one or more ports. The data packets may be forwarded from a primary port (receiving port) to one or more secondary ports (transmitting ports). The ARL may be implemented using digital circuitry, for example. Any switching device that employs an address resolution logic capability may be used to provide the data packet forwarding mechanism. The switching device 112 may be configured with a rule that correctly forwards any data packets having a destination address corresponding to the pre-defined multicast address. The switch is capable of directing or forwarding multicast packets to one or more specific ports, and not to the entire network. Hence, the switching device 112 may forward any such data packets to Port 1 if the portable computing device 116 is the only device using the pre-defined multicast address. In this case, none of these data packets are transmitted to Port 2, for example.

FIG. 2 is a block diagram of a data storage device 200 residing within a docking station (i.e., the docking station referenced in FIG. 1), in accordance with an embodiment of the invention. The data storage device referenced in FIG. 1, may be represented by the detailed block diagram shown in FIG. 2. As illustrated, the data storage device 200 (NAS) may comprise a processing engine 204 that utilizes a processor 240, a random access memory 208, a flash memory 212, an AC power interface 216, a power supply 220, one or more interfaces 224, and one or more data storage drives (such as one or more hard disk drives) 232. The one or more interfaces 224 may comprise any type of communication interface. The one or more interfaces 224 may be used to communicate with the switching device referenced in FIG. 1. The AC power interface 216 and power supply 220 may be used for providing power to the data storage device 200. Once powered up, the data storage device 200 may boot-up and execute a server application software, as previously discussed. The one or more data storage drives 232 may comprise any number of hard drives depending on the data storage requirements of the one or more data computing devices in the network. The random access memory 208 and flash memory 212 may be used for storing and executing the server application software. The processor 240 may be used for executing the server application software. The server application software may be resident in the flash memory 212, for example. The server application software may be resident in the one or more data storage drives 232. The server application software may be downloaded into the flash memory 212 by way of control provided by, for example, the portable computing device referenced in FIG. 1. In a representative embodiment, the processor 240 is implemented within the processing engine 204. The processing engine 204 may perform one or more other digital signal processing functions required by the data storage device 200.

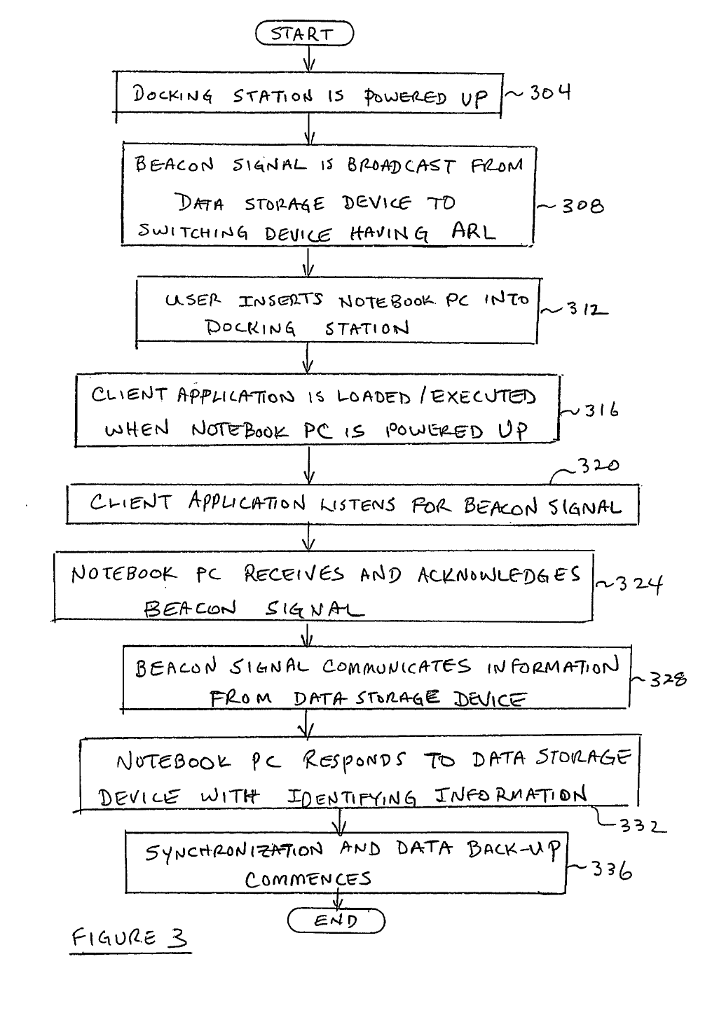

FIG. 3 is an operational flow diagram illustrating a method of detecting the presence of a docking station having data storage functionality and initiating a data storage or data retrieval session, in accordance with an embodiment of the invention. At step 304, the docking station is powered up. A server application software is loaded and executed by the data storage device located within the docking station. The server application software facilitates the transmission of a beacon signal that identifies the data storage device. The beacon signal is transmitted to a portable computing device connected to the docking station and/or one or more networked computing devices. The beacon signal may provide identifying information concerning the docking station's data storage capability. Next at step 308, a beacon signal is broadcast from the data storage device to a switching device. The switching device utilizes address resolution logic (ARL) for forwarding the beacon signal to the portable computing device and/or one or more networked computing devices. The switching device may forward the beacon signal to one or more computing devices that are configured with a pre-defined multicast address. The portable computing device may be configured with the pre-defined multicast address when it is connected to or attached to the docking station. As discussed previously, executing the client application software may load or configure the pre-defined multicast address in the portable computing device. The beacon signal may be continuously or periodically broadcast by the data storage device that is located within the docking station. At step 312, a user inserts his portable computing device (e.g., a notebook PC) into the docking station. The portable computing device contains a copy of the client application software. Next, at step 316, the portable computing device is powered up and the client application software is subsequently loaded and executed. When executed, the client application software appropriately configures a multicast socket with a pre-defined multicast address in the portable computing device. Optionally, the one or more networked computing devices may also contain copies of the client application software. When the client application software is executed in the one or more networked computing devices, the one or more networked computing devices are configured with the appropriate pre-defined multicast address. Next at step 320, the multicast socket of the portable computing device listens for an incoming beacon signal. At step 324, the portable computing device (e.g., notebook PC) receives and acknowledges the beacon signal that is appropriately forwarded by the switching device. At step 328, the beacon signal communicates any required information to the portable computing device. The required information may comprise the MAC address, name, and address of the data storage device, for example. Next, at step 332, the portable computing device (e.g., notebook PC) responds to the data storage device in the docking station. For example, the portable computing device may provide identifying information to the data storage device. The portable computing device and the data storage device may handshake using one or more acknowledgements. At step 336, one or more data storage and data retrieval operations may be performed. For example, the portable computing device may synchronize and perform a data back-up of any data stored in the portable computing device's data storage drive. Other data storage and data retrieval operations may comprise data archiving and data restoration, for example. Similarly, the one or more networked computing devices configured with the pre-defined multicast address may communicate with the data storage device and perform one or more data storage and data retrieval operations. In a representative embodiment, the one or more networked computing devices may perform data storage and data retrieval operations when the docking station and the one or more networked computing devices reside in the same subnet of a network.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method of detecting the presence of a docking station providing data storage functionality comprising:
broadcasting a beacon signal from said docking station, said beacon signal comprising a destination address, said destination address set equal to a predefined multicast address;
receiving said beacon signal by one or more data computing devices; and
responding to said docking station by said one or more data computing devices if said one or more data computing devices implements a multicast socket using said predefined multicast address, said docking station comprising a data storage device, said data storage device providing a storage depository for one or more data files provided by said one or more data computing devices.

2. The method of claim 1 further comprising using a switching device to forward said beacon signal to said one or more data computing devices.

3. The method of claim 2 wherein said switching device provides address resolution logic capable of forwarding one or more packets received at a primary port to one or more secondary ports based on said predefined multicast address.

4. The method of claim 1 wherein said data docking station is networked into a local area network, said docking station providing data storage functionality for one or more data computing devices that are networked in said local area network.

5. The method of claim 4 wherein said docking station and said one or more data computing devices reside within the same subnet of said local area network.

6. The method of claim 1 wherein said one or more data computing devices comprises a portable computing device.

7. The method of claim 6 wherein said portable computing device comprises a notebook or laptop computer.

8. The method of claim 1 wherein said beacon signal comprises a TCP or UDP message.

9. The method of claim 1 wherein said predefined multicast address is selected from any one of one or more unreserved IP multicast addresses.

10. A method for detecting the presence of a docking station providing data storage functionality, and initiating one or more data storage and/or data retrieval operations using said docking station, said method comprising:
first executing a server application software when said docking station is powered up;
broadcasting one or more messages having a destination address configured with a predefined multicast address, said one or more messages generated by said execution of said first software;
second executing a client application software when said portable computing device is powered up and connected to said docking station;
receiving said beacon signal by said portable computing device;
responding to said one or more messages; and
performing said one or more data storage and/or data retrieval operations, said responding and said performing facilitated by said execution of said client application software.

11. The method of claim 10 further comprising using a switching device to forward said one or more messages from a primary port of said switching device to one or more secondary ports of said switching device, said switching device using an address resolution logic.

12. The method of claim 10 wherein said predefined multicast address is selected from any one of one or more unreserved multicast addresses.

13. The method of claim 10 wherein said portable computing device comprises a notebook or laptop computer.

14. The method of claim 10 wherein said docking station comprises a data storage device used for providing said data storage functionality, said data storage device capable of expansion using one or more data storage drives, said data storage device implementing one or more data pools using said one or more data storage drives.

15. The method of claim 10 wherein said second executing is performed after an actuator is used to authenticate said portable computing device.

16. A system for detecting the presence of a docking station providing data storage functionality, said system comprising:
a server application software resident in said docking station;
a client application software resident in a data computing device;
a first processor in said docking station, said first processor executing said server application software to generate one or more signals, said one or more signals identifying said docking station as capable of said providing said data storage functionality;
a second processor in said data computing device, said second processor executing said client application software;
a switching device for forwarding said one or more signals from said docking station to said data computing device, each of said one or more signals comprising a destination address set equal to a predefined multicast address, said multicast address corresponding to a multicast socket implemented by said data computing device, said second processor executing said client application software to facilitate receiving said one or more signals by said data computing device.

17. The system of claim 16 wherein said predefined multicast address is selected from any one of one or more unreserved multicast addresses.

18. The system of claim 16 wherein said data computing device comprises a notebook or laptop computer.

19. The system of claim 16 wherein said docking station comprises a data storage device.

20. The system of claim 19 wherein said one or more signals comprises a MAC address, name, and IP address of said data storage device.

21. The system of claim 16, wherein said switching device comprises an Ethernet switch.
